(19) United States
(12) Patent Application Publication
(10) Pub. No.: US 2012/0246559 A1
(43) Pub. Date: Sep. 27, 2012

(54) METHOD AND SYSTEM FOR ESTIMATING VARIABLE DATA DOCUMENT CONVERSION TIME

(75) Inventors: Matthew DeRoller, Webster, NY (US); Glenn Smits, Macedon, NY (US)

(73) Assignee: Xerox Corporation, Norwalk, CT (US)

(21) Appl. No.: 13/070,278

(22) Filed: Mar. 23, 2011

(51) Int. Cl. G06F 17/00

(52) U.S. Cl. 715/239

(57) ABSTRACT

A method and system for automatically estimating a conversion time of a complex variable data document. A static document that is to be converted to a variable data document can be provided and each variable data object for example, an object number, an object type, and a number of object type variations associated with the document can be tagged utilizing a tagging schema. An estimation logic can be applied to calculate the conversion time by summing the placement average for the object type, the number of object type and the number of object type variations for each object type. A plan file with placeholders for the variable data objects in the document can be automatically created for effectively planning the capacity of a development and design team in quick turnaround schedules.

### TECHNICAL FIELD

Embodiments are generally related to VDP (Variable Data Printing) methods and systems. Embodiments are additionally related to the estimation of variable data document conversion time. Embodiments are also related to rendering devices and networks.

### BACKGROUND OF THE INVENTION

Networked rendering devices such as printers, copy machines, scanners and the like can interact and communicate with other networked devices such as clients/servers, etc. over a network. Such networked rendering devices are often utilized to render high volumes of documents (e.g., a rendering job) with special finishing feature such as, for example, binding and formatting.

Variable data printing (VDP) is a form of on-demand printing in which elements such as, for example, text, graphics and images are changed from one printed piece to the next, without stopping or slowing down the printing process, while utilizing information from a database or an external file. For example, a set of personalized mailings, each with the same basic layout, can be rendered with a different name and address on each letter. VDP is often employed for direct marketing, customer relationship management, advertising and invoicing and also for self-mailers, brochures or postcard campaigns.

VDP can be automated by performing a multi step programming operation that initially converts a static document to a variable data document, which includes a number of variables that can be employed to render the document in a suitable form. The conversion process can be lengthy depending on the complexity of the document. Prior art approaches for estimating the conversion process of extremely complex documents are typically inaccurate, which affects capacity planning, delivery dates, and vendor credibility. Additionally, the dynamic data elements and their variations must be manually identified by a designer which is time consuming and labor intensive.

Based on foregoing, it is believed that a need exists for an improved system and method for accurately estimating a variable data document conversion time, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved variable data printing methods and systems.

It is another aspect of the disclosed embodiments to provide for an improved system and method for converting a static document into a variable data document.

It is further aspect of the disclosed embodiments to provide for an improved method and system for accurately estimating a variable data document conversion time.

The aforementioned aspects and other objectives and advantages can now be achieved as described herein. A method and system for automatically estimating a conversion time of a complex variable data document is disclosed herein. A static document (e.g., single page or multi-page) that is to be converted to a variable data document can be provided and each variable data object (e.g., an object number, an object type, a number of object type variations, etc) associated with the document can be tagged utilizing a tagging schema (e.g., XML (Extensible Markup Language) or XMP (Extensible Metadata Platform)). An estimation logic can be utilized to calculate the conversion time by summing the placement average with respect to, for example, the object type, the number of object type and the number of object type variations for each object type. Additionally, a plan file with placeholders for the variable data objects in the document can be automatically created for effectively planning the capacity of a development and design team in quick turnaround schedules.

A simple tag can be employed to indicate the object number, the object type, and the variations. The tagged document can be exported to the XML format in order to encode the document in a machine readable format. The XML format document can be further read via a tool that applies the estimation logic in order to calculate the conversion time. The plan file provides definition placeholders for all variable data objects in the document thereby eliminating the need for manual assistance. The variations associated with the variable data document can be controlled by the logic associated with the plan file.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example of a rendering device coupled to a data-processing apparatus through a network, in accordance with the disclosed embodiments;

FIG. 2 illustrates a block diagram of a variable data document conversion time estimation system, in accordance with the disclosed embodiments;

FIG. 3 illustrates a high level flow chart of operation illustrating logical operational steps of a method for accurately estimating a variable data document conversion time, in accordance with the disclosed embodiments;

FIG. 4 illustrates an exemplary variable data document associated with variable data objects, in accordance with the disclosed embodiments;

FIG. 5 illustrates an exemplary tagged document associated with variable data objects, in accordance with the disclosed embodiments; and

FIG. 6 illustrates a flow diagram illustrating logical operational steps of a method for estimating variable data document conversion time and creating a plan file, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

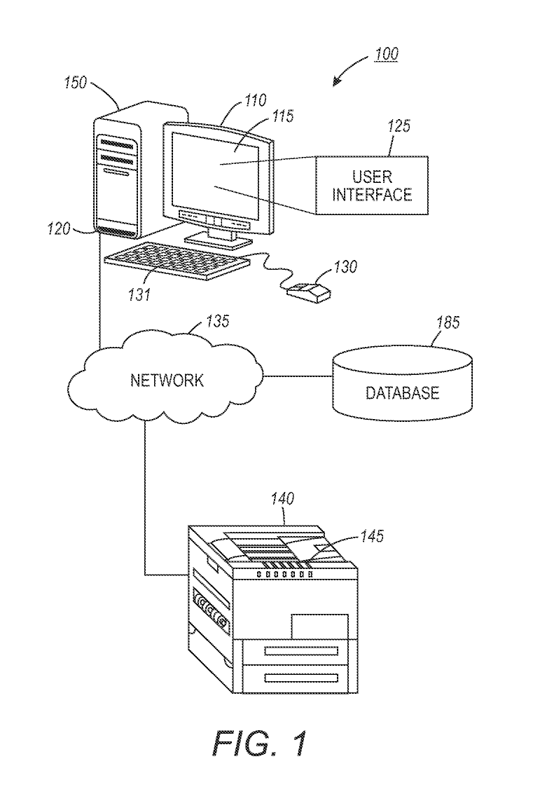

Referring to FIG. 1, a system 100 generally includes a rendering device 140 that can communicate with a data-processing apparatus 110 through a network 135. In some embodiments, rendering device 140 may be a rendering device such as a printer, scanner, copy machine, workstation, mobile display, a combination thereof, etc. In other embodiments, rendering device 140 may be an MFD (Multi-Function Device). The data-processing apparatus 110 can be, for example, a computer or other computing device, and can include a central processor 120, a display device 115, a keyboard 131, and a pointing device 130 (e.g., mouse, track ball, pen device, touch, tactile, haptic, or the like). Additional input/output devices, such as the rendering device 140 may be included in association with the data-processing apparatus 110 as desired.

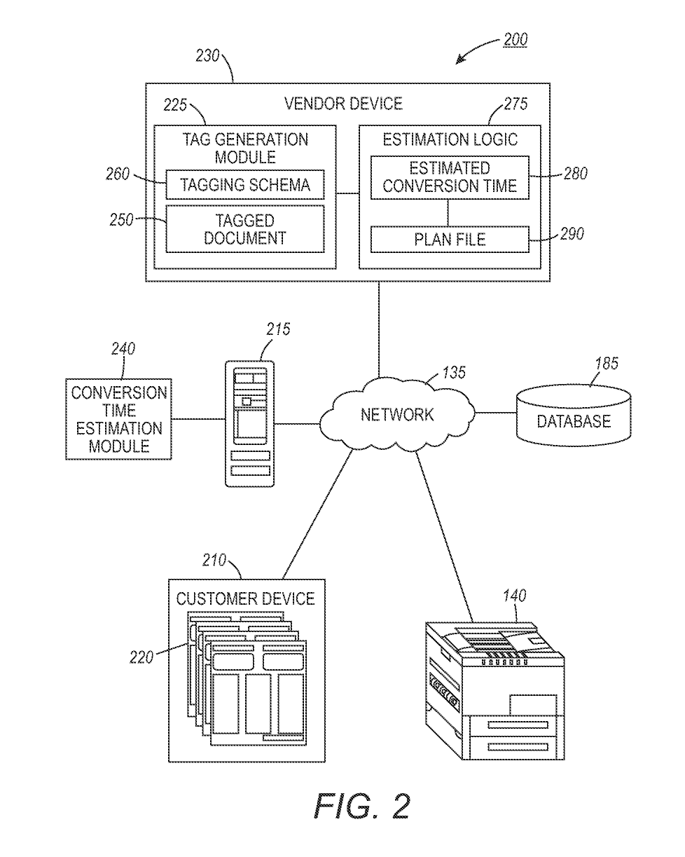

Note that as utilized herein, the term “rendering device” may refer to an apparatus or system such as a printer, scanner, fax machine, copy machine, etc., and/or a combination thereof (e.g., an MFD). In some embodiments, the rendering device 140 may be implemented with a single rendering function such as printing. In other embodiments, the rendering device 140 can be configured to provide multiple rendering functions, such as scanning, faxing, printing and copying. Note that the rendering devices 142 and 144 illustrated herein with respect to FIG. 2 are generally analogous or similar to rendering device 140.

The data-processing apparatus 110 shown in FIG. 1 can be coupled to the rendering device 140 (and other rendering devices) through a computer network 135 in the context of a print shop environment. A network 135 may employ any network topology, transmission medium, or network protocol. The network 135 may include connections, such as wire, wireless communication links, or fiber optic cables. In some embodiments, network 135 can be the Internet representing a worldwide collection of networks and gateways that use the Transmission Control Protocol/Internet Protocol (TCP/IP) suite of protocols to communicate with one another. In other embodiments, network 135 may be an internal network such as an “Intranet” or network dedicated to a particular organization, business, government agency and so forth.

In some embodiments, the rendering device 140 can include a user interface 145, such as a panel menu. The panel menu may be used to select features and enter other data in the rendering device 140. Such interfaces may include, for example, touch screens having touch activated keys for navigating through an option menu or the like. A driver program, for example, can be installed on the data-processing apparatus 110 and can reside on the host device's hard drive 150. The driver program may be activated through an application interface so that a user may generate a print job with the driver for processing by the rendering device 140.

In some embodiments, the data-processing apparatus 110 may include a GUI 125 that allows a user to interact with the data-processing apparatus 110, the network 135 and networked devices such as the rendering device 140 shown in FIG. 1. The user interface 125 displays information and receives data through device display and/or the keyboard/mouse combination. The interface 125, also serves to display results, whereupon the user may supply additional inputs or terminate a given session. The data-processing apparatus 110 can be, for example, any computing device capable of being integrated within a network, such as a PDA, personal computer, cellular telephone, point-of-sale terminal, server, etc.

The input device of the rendering device 140, for example, may be a local user interface 145, such as a touch-screen display or separate keypad and display or a memory fob or the like as discussed above. Alternatively or additionally, the input device may be a wireless port that receives a wireless signal containing constraint data from a portable device. The wireless signal may be an infrared or electromagnetic signal. A system administrator may input constraint data through the local user interface 145 by manipulating the touch screen, keypad, or communicating via wireless messages through the wireless port. The administrator's portable device that communicates wirelessly may be a personal digital assistant (PDA), or the like, as noted above.

The following description is presented with respect to embodiments of the present invention, which can be embodied in the context of a customer device 210 and rendering device 140 depicted in FIG. 2. The disclosed embodiments, however, are not limited to any particular application or any particular environment. Instead, those skilled in the art will find that the disclosed embodiments may be advantageously applied to a variety of system and application software, including database management systems, word processors, and the like. Moreover, the disclosed methods and systems can be embodied on a variety of different platforms, including Macintosh, UNIX, LINUX, and the like. Therefore, the description of the exemplary embodiments, which follows, is for purposes of illustration and not considered a limitation.

Note that programs defining functions with respect to the disclosed embodiments may be delivered to a data storage system or a computer system via a variety of signal-bearing media, which include, without limitation, non-writable storage media (e.g., CD-ROM), writable storage media (e.g., hard disk drive, read write CD ROM, optical media), system memory such as but not limited to Random Access Memory (RAM), and communication media, such as computer and telephone networks including, for example., Ethernet, the Internet, wireless networks, other networked systems.

FIG. 2 illustrates a block diagram of the variable data document conversion time estimation system 200, in accordance with the disclosed embodiments. Note that in FIGS. 1-6, identical or similar blocks are generally indicated by identical reference numerals. The variable data document conversion time estimation system 200 generally includes the network infrastructure 135 associated with the networked rendering device 140, the customer device 210, a vendor device 230 and a server 215. Data-processing system 110 depicted in FIG. 1 can be, for example, a server, the customer device 210 or the vendor device 230. Other devices such as, for example, desktops, network devices, tablet computing devices, laptop computers, Smartphones, mobile phones, etc may also be included in the network 135, as service providers.

The system 200 generally employs digital printing technology that customizes communication by linking the database 185 that contain the content for printed documents to the rendering device 140, such as a digital press. The database 185 can be configured to include a table containing all the changeable or variable elements with respect to the document such as, for example, text, graphics, and photographs. A conversion time estimation module 240 associated with the server 215 can be adapted for automatically estimating a conversion time of a complex variable data document.

Note that as utilized herein, the term “module” may refer to a physical hardware component and/or to a software module. in the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (Le., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

Examples of signal-bearing media can include, for example, recordable-type media, such as floppy disks, hard disk drives, CD ROMs, CD-Rs, etc., and transmission media, such as digital and/or analog communication links. Examples of transmission media can also include devices such as modems, which permit information to be transmitted over standard telephone lines and/or the more advanced digital communications lines.

The customer device 210 transmits a static document 220 (e.g., single page or multi-page) that is to be converted to a variable data document 400 to the vendor device 230. The variable data document 400 can be a personalized document received from a variable data source such as, the customer device 210 for providing variable data. The variable data document 400 rendering enables the mass customization of documents 220 via digital print technology, as opposed to the ‘mass-production’ of a single document utilizing offset lithography. The vendor device 230 can be configured to include a tag generation module 225 and estimation logic 275. Note that “document” refers to one or more pages in a project corresponding to a set or record of variable data. Variable data employed to personalize each document can be received from the database 185.

Each variable data object such as, for example, object number 520, object type 510, and/or a number of object type variations 530 associated with the document 220, can be tagged utilizing a tagging schema 260 configured in association with the tag generation module 225. A simple tag can be employed to indicate the object number 520, the object type 510, and the variations 530. The tag may be a file header or other known identification scheme. Tag recognition is a function of reading the header or other such tag information and processing the document appropriately. Note that the tagging schema 260 can be for example, based on XML (Extensible Markup Language) or XMP (Extensible Metadata Platform) format or another appropriate, depending upon design considerations. The estimation logic 275 can be applied to calculate the conversion time 280 by summing the placement average for object type 510, number of object type 520 and number of object type variations 530 for each object type.

For example, an XML exporter can be employed to export the tagged document 250 to an extensible markup language (XML) format in order to encode the document 400 in a machine readable format. The XML is developed by the W3C as a pared down version of Standard Generalized Mark-up Language (SGML) which is designed specially for World Wide. Feb (Web) documents. The XML enables designers to create their own customized tags to provide functionality not available with HTML. For example, XML supports links that point to multiple documents as opposed to HTML links, which can reference just one destination each. An XML reader tool reads the XML format document for applying estimation logic 275 in order to calculate the conversion time 280.

A plan file 290 with placeholders for the variable data objects in the document 220 can be automatically created for effectively planning the capacity of a development and design team in quick turnaround schedules. The plan file 290 includes definition placeholders for all variable data objects in the document 220 thereby eliminating the need for manual assistance. The variations associated with the variable data document can be controlled by the logic associated with the plan file 290.

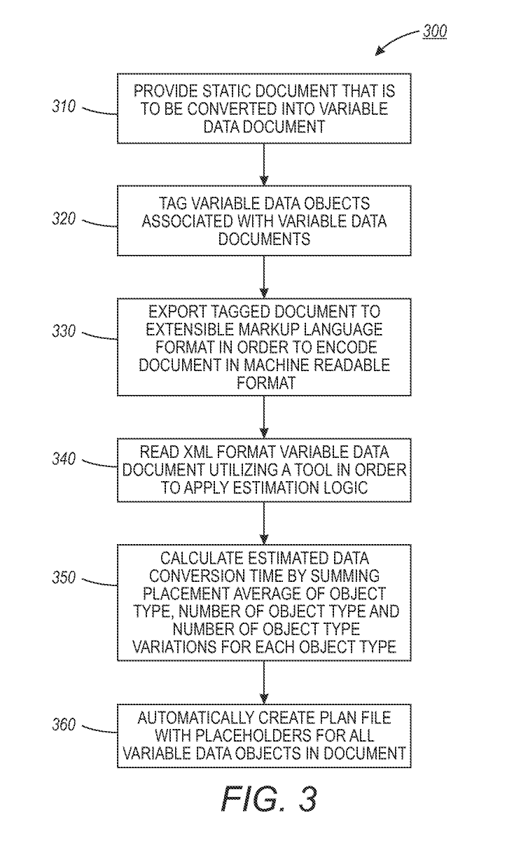

FIG. 3 illustrates a high level flow chart of operations illustrating logical operational steps of a method 300 for accurately estimating a variable data document conversion time, in accordance with the disclosed embodiments. The static document 220 that is to be converted into the variable data document 400 can be provided to the vendor device 230, as illustrated at block 310. Thereafter, as depicted at block 320, one or more variable data objects associated with the variable data document 400 can be tagged.

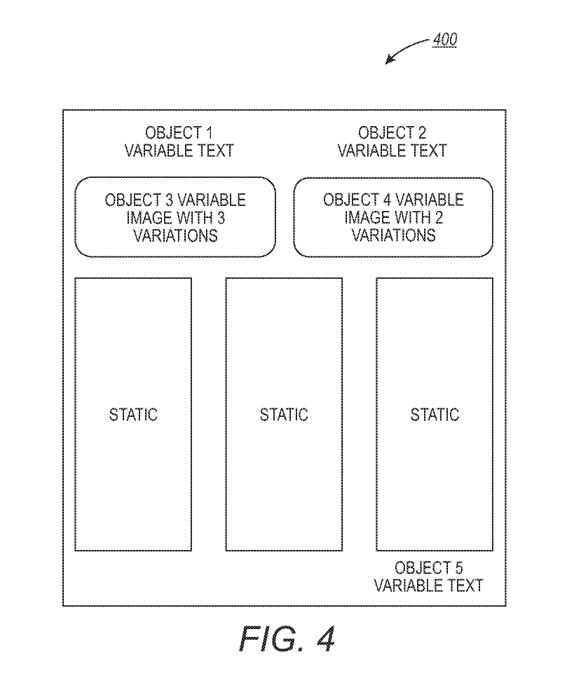

FIG. 4 illustrates an exemplary variable data document 400 associated with variable data objects, in accordance with the disclosed embodiments. The variable data document 400 includes multiple pages with hundreds of variables. The variable data document 400 includes a set of master elements that are common across copies of a document (reusable data) with a set of variable elements that change from copy to copy. The tagged document 250 can be exported to the XML format and/or XMP format in order to encode the document 400 in a machine readable format, as indicated at block 330.

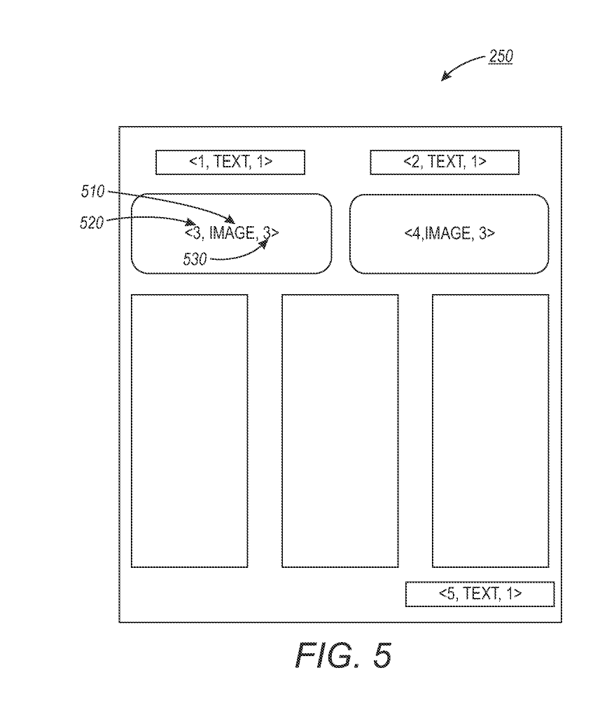

FIG. 5 illustrates an exemplary tagged document 250 with variable data objects such as, for example, object number 510, object type 520, and variations 530 (number of possible variations). The XML format of the variable data document 400 can be read utilizing the XML reader tool 270 in order to apply the estimation logic 275, as illustrated at block 340. The estimated conversion time 280 can be calculated by summing key factors such as, placement average for object type 520, number of object types 510, and number of object type variations 530 of each variable data object, as depicted at block 350.

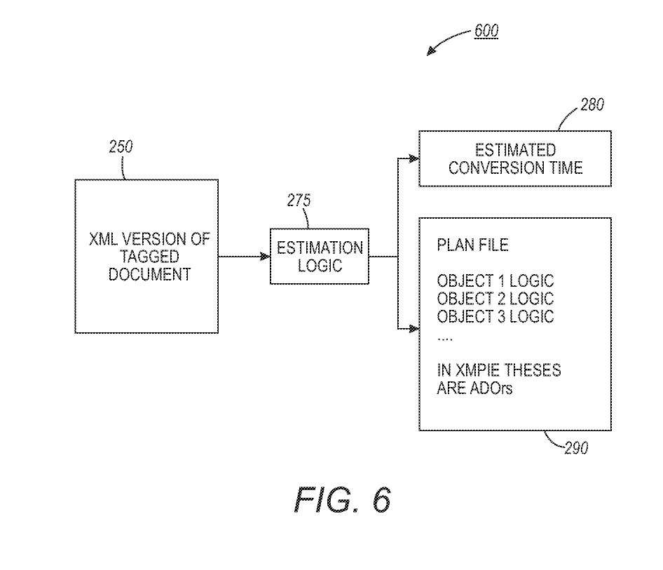

FIG. 6 illustrates a flow diagram illustrating logical operational steps of a method 600 for estimating variable data document conversion time and creating the plan file 290, in accordance with the disclosed embodiments. The estimation Logic can be calculated as follows:

Conversion_Time_Estimate=(Placement_Average_Object_Type_{—}1×Number of Object_Type_{—}1)×Object_Type_{—}1_Variations)+(Placement_Average_Object_Type_{—}2×Number_of_Object_Type_{—}2)×Object_Type_{—}2_Variations)+. . . (Continue for each object type)

Where Placement_Average_Object_Type_x represents the known average time based upon experience of vendor in minutes. The Number_of_Object_Type_x represents number of objects of that particular type in the document and Object_Type_x_Variations represents number of object variations in the document. Each variation can be driven by logic in the plan file 290 which can add to the complexity of the object. The plan the 290 with placeholders for the variable data objects in the document can be automatically created for effectively planning the capacity of a development and design team in quick turnaround schedules.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for automatically estimating the conversion time of a complex variable data document, said method comprising:
providing a static document that is to be converted to a variable data document in order to thereafter tag each variable data object associated with said static document utilizing a tagging schema;
applying an estimation logic to calculate a conversion time of said variable data document by summing said variable data object for each object type; and
automatically creating a plan file with a plurality of definition placeholders for said variable data object in said document in order to effectively plan capacity of development and design thereof in a rapid turnaround schedule.

2. The method of claim 1 further comprising configuring said variable data object associated with said document to comprise at least one of the following types of objects:
an object number;
an object type; and
a number of object type variations.

3. The method of claim 1 further comprising tagging each variable data object associated with said static document in an extensible markup language format.

4. The method of claim 3 further comprising:
exporting said tagged document to said extensible markup language format in order to encode said document in a machine readable format; and
reading said extensible markup language format document via a tool that applies said estimation logic in order to calculate said conversion time.

5. The method of claim 1 further comprising tagging each variable data object associated with said static document in an extensible metadata platform format.

6. The method of claim 1 further comprising controlling variations associated with said variable data document via a particular logic associated with said plan file.

7. The method of claim 4 further comprising tagging each variable data object associated with said static document in an extensible metadata platform format.

8. The method of claim 4 further comprising controlling variations associated with said variable data document via a particular logic associated with said plan file.

9. A system for automatically estimating the conversion time of a complex variable data document, said system comprising:
a processor;
a data bus coupled to said processor; and
a computer-usable medium embodying computer code, said computer-usable medium being coupled to said data bus, said computer program code comprising instructions executable by said processor and configured for:
providing a static document that is to be converted to a variable data document in order to thereafter tag each variable data object associated with said static document utilizing a tagging schema;
applying an estimation logic to calculate a conversion time of said variable data document by summing said variable data object for each object type; and
automatically creating a plan file with a plurality of definition placeholders for said variable data object in said document in order to effectively plan capacity of development and design thereof in a rapid turnaround schedule,

10. The system of claim 9 wherein said instructions are further configured for associating said variable data object with said document to comprise at least one of the following types of objects:
an object number;
an object type; and
a number of object type variations.

11. The system of claim 9 wherein said instructions are further configured for tagging each variable data object associated with said static document in an extensible markup language format.

12. The system of claim 11 wherein said instructions are further configured for:
exporting said tagged document to said extensible markup language format in order to encode said document in a machine readable format; and
reading said extensible markup language format document via a tool that applies said estimation logic in order to calculate said conversion time.

13. The system of claim 9 wherein said instructions are further configured for tagging each variable data object associated with said static document in an extensible metadata platform format.

14. The system of claim 9 wherein said instructions are further configured for controlling variations associated with said variable data document via a particular logic associated with said plan file.

15. A system for automatically estimating the conversion time of a complex variable data document, said system comprising:
a processor;
a data bus coupled to said processor; and
a computer-usable medium embodying computer code, said computer-usable medium being coupled to said data bus, said computer program code comprising instructions executable by said processor and configured for:
providing a static document that is to be converted to a variable data document in order to thereafter tag each variable data object associated with said static document utilizing a tagging schema;
applying an estimation logic to calculate a conversion time of said variable data document by summing said variable data object for each object type; and
automatically creating a plan file with a plurality of definition placeholders for said variable data object in said document in order to effectively plan capacity of development and design thereof in a rapid turnaround schedule, wherein said instructions are further configured for associating said variable data object with said document to comprise at least one of the following types of objects: an object number; an object type; and a number of object type variations.

16. The system of claim 15 wherein said instructions are further configured for tagging each variable data object associated with said static document in an extensible markup language format.

17. The system of claim 16 wherein said instructions are further configured for:
exporting said tagged document to said extensible markup language format in order to encode said document in a machine readable format; and
reading said extensible markup language format document via a tool that applies said estimation logic in order to calculate said conversion time.

18. The system of claim 15 wherein said instructions are further configured for tagging each variable data object associated with said static document in an extensible metadata platform format.

19. The system of claim 15 wherein said instructions are further configured for controlling variations associated with said variable data document via a particular logic associated with said plan file.

20. The system of claim 18 wherein said instructions are further configured for tagging each variable data object associated with said static document in an extensible metadata platform format.
